(19) United States
(12) Patent Application Publication
(10) Pub. No.: US 2007/0188419 A1
(43) Pub. Date: Aug. 16, 2007

(54) VOLTAGE TRANSFER METHOD AND APPARATUS USING ORGANIC THIN FILM TRANSISTOR AND ORGANIC LIGHT EMITTING DIODE DISPLAY DEVICE INCLUDING THE SAME

(75) Inventors: Jung-woo Kim, Yongin-si (KR); Sung-Kee Kang, Yongin-si (KR); Tae-sik Oh, Yongin-si (KR); Ho-nyeon Lee, Yongin-si (KR); Young-tea Chun, Yongin-si (KR); Young-gu Lee, Yongin-si (KR)

Correspondence Address: CANTOR COLBURN, LLP, 55 GRIFFIN ROAD SOUTH, BLOOMFIELD, CT, 06002, US

(73) Assignee: SAMSUNG ELECTRONICS CO., LTD., Suwon-si (KR)

(21) Appl. No.: 11/609,087

(22) Filed: Dec. 11, 2006

(30) Foreign Application Priority Data
Feb. 11, 2006 (KR) 10-2006-0013333

(51) Int. Cl. G09G 3/30

(52) U.S. Cl. 345/76

(57) ABSTRACT

A voltage transfer method and apparatus using an organic thin film transistor (“TFT”) and an organic light emitting diode (OLED) display device including the same to increase response speed of the organic TFT. The voltage transmission method includes turning on the organic TFT, applying a first voltage having a plurality of different levels to one side of the organic TFT while the organic thin film transistor is turned on, and outputting a second voltage from the other side of the organic TFT.

This application claims priority to Korean Patent Application No. 10-2006-0013333, filed on Feb. 11, 2006, and all the benefits accruing therefrom under 35 U.S.C. §119, the contents of which in its entirety are herein incorporated by reference.

### BACKGROUND OF THE INVENTION

1. Field of the Invention

The present invention relates to a voltage transfer method and apparatus, and an organic light emitting diode display device including the same, and more particularly, to a voltage transfer method and apparatus using an organic thin film transistor and an organic light emitting diode display device including the same.

2. Description of the Related Art

With the advent of digital broadcasting, the demand for flat panel displays is increasing. Accordingly, organic light emitting diode (“OLED”) displays have been highlighted as next generation displays, after plasma display panels (“PDPs”) and liquid crystal displays (“LCDs”). As next generation flat panel displays, OLED displays have low power consumption, a wide viewing angle and high chromatic purity. Also, organic LED displays can be manufactured in a low temperature process, and thus can be used as flexible displays formed of flexible materials such as plastics. OLED displays are self-light emitting devices which illuminate when a current flows, and have response speed a thousand times faster than LCDs. In addition, OLED displays do not require a backlight, a color filter, etc., which LCDs require. Thus, OLED displays are advantageous not only in terms of performance, but also in terms of manufacturing costs.

OLED displays are current-driven devices operated by organic thin film transistors (“TFTs”).

Organic TFTs are advantageous compared with the conventional silicon semiconductors in that they have a simpler and lower cost manufacturing process and will not break easily due to impact. Accordingly, the organic TFTs can be arranged in plastic printed circuit boards (“PCBs”) which can be bent or folded.

However, when driving an OLED display using an organic TFT, a voltage required to drive the OLED display cannot be obtained within a desired time due to the low mobility of the organic TFT when the organic TFT is turned on. In addition, since voltage transfer cannot be completed within a desired time, a background emission exists in a flat panel display as shown in FIG. 1. The background emission indicates that a light is emitted at a portion 11 other than a desired picture 10. It is thus difficult to implement a black level representation in an OLED display due to the background emission.

### BRIEF SUMMARY OF THE INVENTION

The present invention provides a voltage transfer method and apparatus, as well as an organic light emitting diode (“LED”) display device including the same, in which a desired voltage is quickly transferred to a load connected to an organic thin film transistor (“TFT”) by supplying a plurality of different levels of data voltage when the organic TFT is turned on,.

According to an exemplary embodiment of the present invention, a voltage transfer method includes: turning on an organic thin film transistor (“TFT”), applying a first voltage having a plurality of different levels to one side of the organic TFT while the organic TFT is turned on, and outputting a second voltage from the other side of the organic TFT.

According to another exemplary embodiment of the present invention, a voltage transfer apparatus includes: an organic thin film transistor (“TFT”) arranged to be turned on by a first input voltage and transfer a second input voltage to an output terminal as an output voltage while the TFT is in a turn-on state, a first driving portion arranged to output the first input voltage, and a second driving portion arranged to output the second input voltage, wherein the second driving portion outputs a voltage having a plurality of different levels as the second input voltage while the organic TFT is turned on.

According to another exemplary embodiment of the present invention, an organic light emitting diode (“OLED”) display device includes: a first driving portion arranged to output a first voltage, a second driving portion arranged to output a second voltage having a plurality of different levels, and a plurality of organic thin film transistor (“TFT”) pixels arranged to be selected by the first voltage, transfer a third voltage from the second voltage and emit a light according to the third voltage while being selected.

### BRIEF DESCRIPTION OF THE DRAWINGS

The above and other aspects, features and advantages of the present invention will become more apparent by describing in more detail exemplary embodiments thereof with reference to the attached drawings in which:

FIG. 1 illustrates an example of background emission in a conventional organic light emitting diode (“OLED”) display device;

FIG. 2 illustrates a circuit schematic configuration of an OLED display device;

FIG. 3 illustrates voltages input to an organic thin film transistor (“TFT”) according to voltages applied to a switching TFT of the OLED display device illustrated in FIG. 2; and

FIG. 4 illustrates data voltages of different levels and a gate voltage applied to a driving TFT according to an exemplary embodiment of the present invention.

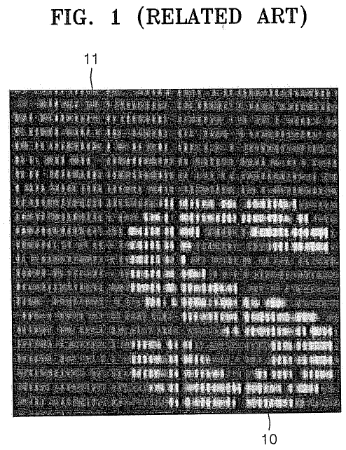

### DETAILED DESCRIPTION OF THE INVENTION

The invention now will be described more fully hereinafter with reference to the accompanying drawings, in which exemplary embodiments of the present invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Hereinafter, the present invention will be described more fully with reference to the accompanying drawings, in which exemplary embodiments of the present invention are shown.

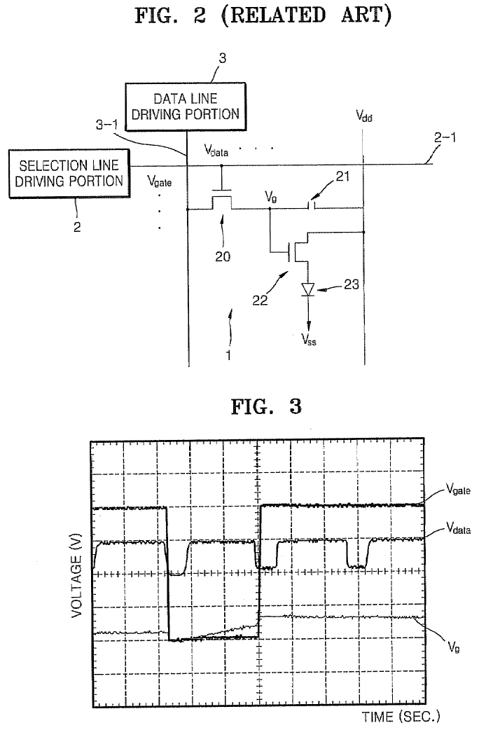

FIG. 2 illustrates a circuit schematic configuration of a conventional organic light emitting diode (“OLED”) display device. The OLED display device includes a plurality of organic thin film transistor (“TFT”) pixels 1, a selection line driving portion 2 and a data line driving portion 3.

Each of the organic TFT pixels 1 is driven by a selection voltage V_{gate} applied by the selection line driving portion 2 to a corresponding selection line 2-1 (e.g., gate line 2-1) and a data voltage V_{data} applied by the data line driving portion 3 to a corresponding data line 3-1. Each of the organic TFT pixels 1 includes a switching TFT 20, a capacitor 21, a driving TFT 22 and an OLED 23. Here, the switching TFT 20 and the driving TFT 22 are organic TFTs. In an OLED display device, even when a scan signal, that is, V_{gate} addresses another selection line 2-1, at least two TFTs 20 and 22 are needed as illustrated in FIG. 2 in order to transfer a uniform current to a pixel. A pixel 1 having both the switching TFT 20 and the driving TFT 22 have a high aperture ratio because the number of TFTs forming the pixel is small, and has excellent reliability and productivity. However, a threshold voltage required to turn on the driving TFT 22 changes due to variations in the manufacturing process or a continuous drive circuit. Accordingly, at the same data voltage, the current transferred to the organic LED 23 changes, thereby changing brightness of a generated light from the pixel 1.

FIG. 3 illustrates voltages input to the driving TFT 22 illustrated in FIG. 2 according to a voltage applied to the switching TFT 20 illustrated in FIG. 2. When the selection voltage V_{gate} applied to the selection line 2-1 is a low level, that is, when the switching TFT 20 is in a selection period, namely, a turn-on state, and when the data voltage V_{data} supplied to the data line 3-1 maintains a uniform level as illustrated in FIG. 3, V_{g} supplied as a gate voltage to the driving TFT 22 reaches a required level slowly due to a low mobility caused by an organic property of the switching TFT 20. Accordingly, V_{g} cannot reach the required level in a given time period.

To solve the problem described above, the data line driving portion 3 provides a data voltage having a reference level, for example, a plurality of different levels substantially larger than a level of 0V to the data line 3-1 in the selection period in the present exemplary embodiment. In other words, the capacitor 21 becomes charged to make the gate voltage V_{g} of the driving TFT 22 reach a desired level quickly by providing a high voltage impulse as the data voltage in an early time period when the switching TFT 20 is turned on by V_{gate}. Here, the data voltage V_{data} may have two or more voltage levels.

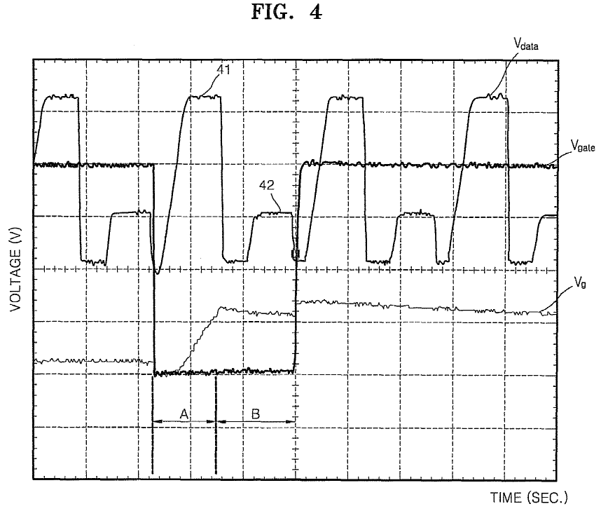

FIG. 4 illustrates data voltages of different levels and a gate voltage to be applied to a driving TFT applied according to an exemplary embodiment of the present invention.

Referring to FIG. 4, the data voltage V_{data} has a first level 41 as high as a high voltage impulse during period A, and applies a desired voltage of a second level 42 during period B. During period A, the gate voltage V_{g} approaches and substantially reaches the second level 42 quickly and then substantially maintains the required second level 42 during the period B.

A level 41 and width A of the impulse voltage vary based on characteristics of employed TFTs or capacitor 21. The impulse voltage level 41 is desirably twice the second level 42 or more.

According to an exemplary embodiment of the present invention, a response speed of an organic TFT having a low mobility can be increased by supplying a data voltage V_{data} of the two or more levels whose first level is higher than that of the others and the first level or a width of the first level of the data voltage V_{data} is adjusted according to organic TFT characteristics. Also, when the response speed of the organic TFT increases, background emission in an OLED display device can be prevented and the black level display can be realized.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A voltage transfer method, the method comprising:
turning on an organic thin film transistor (TFT);
applying a first voltage having a plurality of different levels to one side of the organic TFT while the organic TFT is turned on; and
outputting a second voltage from the other side of the organic TFT.

2. The voltage transfer method of claim 1, wherein the first voltage comprises:
a first level voltage; and
a second level voltage smaller than the first level voltage.

3. The voltage transfer method of claim 2, wherein the second voltage is substantially identical with the second level voltage.

4. The voltage transfer method of claim 2, wherein at least one of a level and a width of the first level voltage are determined according to characteristics of the organic TFT.

5. A voltage transfer apparatus, comprising:
an organic thin film transistor (TFT) arranged to be turned on by a first input voltage and transfer a second input voltage to an output terminal as an output voltage while the TFT is in a turn-on state;
a first driving portion arranged to output the first input voltage; and
a second driving portion arranged to output the second input voltage,
wherein the second driving portion outputs a voltage having a plurality of different levels as the second input voltage while the organic TFT is turned on.

6. The voltage transfer apparatus of claim 5, wherein the second driving portion outputs a first level voltage and a second level voltage as the second input voltage, the second level voltage is smaller than the first level voltage.

7. The voltage transfer apparatus of claim 6, wherein the output voltage is substantially identical with the second level voltage.

8. The voltage transfer apparatus of claim 6, wherein at least one of a level and a width of the first level voltage are determined according to characteristics of the organic TFT.

9. An organic light emitting diode (OLED) display device, comprising:
a first driving portion arranged to output a first voltage;
a second driving portion arranged to output a second voltage having a plurality of different levels; and
a plurality of organic thin film transistor (TFT) pixels arranged to be selected by the first voltage, transfer a third voltage from the second voltage and emit a light according to the third voltage while being selected.

10. The OLED display device of claim 9, wherein the second driving portion outputs a first level voltage and a second level voltage as the second voltage, the second level voltage is smaller than the first level voltage.

11. The OLED display device of claim 10, wherein the third voltage has a level substantially identical with the second level voltage.

12. The OLED display device of claim 9, wherein each of the organic TFT pixels comprises:
a first organic TFT arranged to be turned on by the first voltage and then input the second voltage to output the third voltage;
a second organic TFT arranged to be turned on by the third voltage; and
an OLED arranged to emit a light by a current input by the turning on of the second organic TFT.

13. The OLED display device of claim 12, wherein the second voltage comprises:
a first level voltage; and
a second level voltage which is smaller than the first level voltage.

14. The OLED display device of claim 13, wherein the third voltage has a level substantially identical with the second level voltage.
